(19) United States
(12) Patent Application Publication
(10) Pub. No.: US 2024/0207940 A1
(43) Pub. Date: Jun. 27, 2024

(54) MANUFACTURING APPARATUS FOR ADDITIVE MANUFACTURING OF THREE-DIMENSIONAL COMPONENTS, AND METHOD OF MANUFACTURE

(71) Applicant: AMCM GMBH, Starnberg (DE)

(72) Inventor: Georg FEY, Wessling (DE)

(21) Appl. No.: 18/291,203

(22) PCT Filed: Jul. 14, 2022
(86) PCT No.: PCT/EP2022/069718

§ 371 Date: Jan. 22, 2024

(30) Foreign Application Priority Data
Jul. 20, 2021 (DE) 102021118697.8

(51) Int. Cl. B22F 12/30; B22F 10/73; B22F 12/00; B22F 12/20; B22F 12/88; B33Y 10/00; B33Y 30/00; B33Y 40/00

(52) U.S. Cl. CPC B22F 12/30; B22F 10/73; B22F 12/20; B22F 12/38; B22F 12/88; B33Y 10/00; B33Y 30/00; B33Y 40/00

(57) ABSTRACT

Disclosed is a manufacturing device for additive manufacturing, of preferably metallic and/or ceramic, three-dimensional components by layer-by-layer application by at least one coating unit and locally selective solidification of a build-up material by at least one irradiation unit, including a building platform, wherein the building platform has an upper portion with at least one upper opening, on which the component can be built-up, as well as a lower portion with at least one closable lower opening.

The invention relates to a manufacturing device for the additive manufacturing of three-dimensional components, a corresponding manufacturing method as well as a corresponding system.

Manufacturing devices and corresponding methods for the additive manufacturing of three-dimensional components by layer-by-layer application and locally selective solidification of a build-up material are known in principle from the prior art. For layer-by-layer application, at least one corresponding coating unit is usually provided. For the local selective solidification, at least one corresponding irradiation unit (e.g. comprising at least one laser) is usually provided.

Furthermore, it is known to build up three-dimensional components on a building platform which can be held and/or moved by a carrier (building platform carrier). Such a manufacturing device is known, for example, from WO 2014/044 705 A1. There, a manufacturing device is described which has a construction space in which a three-dimensional object is manufactured. Furthermore, a container for receiving the manufactured object and the unsolidified powder surrounding this object is described. The container in turn surrounds a volume and is open on its downwardly facing side. The open side of the container can be closed by a closing element, and the manufactured object and the unsolidified powder surrounding this object can be pushed out of the construction space together with the closing element from below through an open side into the container. This allows the manufactured item and the powder surrounding it to be removed from the manufacturing device in a closable container without powder escaping from the container. This method of removal is found to be comparatively cumbersome and impractical in use.

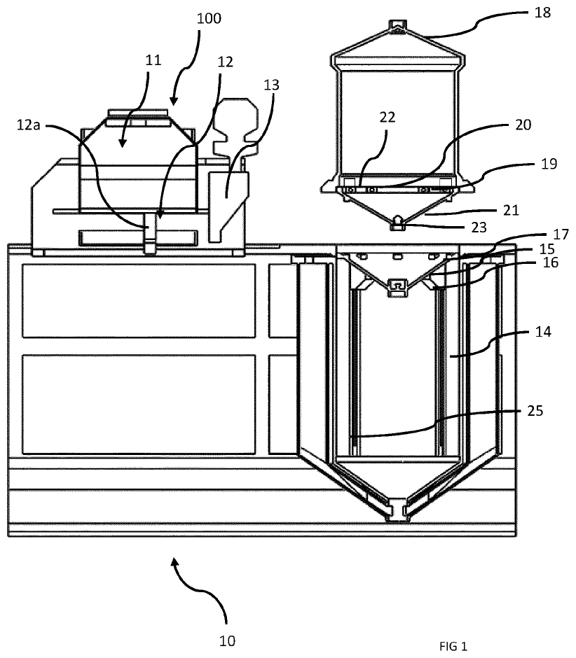

Furthermore, with regard to the prior art, reference should be made to US 2008/0241404 A1, which also discloses a device for manufacturing a three-dimensional object. However, the device there does not work with an irradiation unit (e.g. comprising at least one laser), but with a liquid as (locally applied) binder to form the desired three-dimensional structures (according to the principle of “binder jetting”). This process must fulfil fundamentally different conditions than a process that works with an irradiation unit or a localised irradiation of powder, so that the considerations there are fundamentally not transferable to a manufacturing device that works with an irradiation unit. For example, as can also be seen in FIG. 1 of US 2008/0241404 A1, the object to be manufactured (marked there with the reference sign 18) “floats” in the powder bed, so to speak, i.e. in particular does not have to be supported by the building platform. In this respect, it is possible in US 2008/0241404 A1 to form a comparatively fine-meshed grid on an upper side of a structure designated as a building platform. Through this grid, it should then be possible to remove excess powder after the manufacturing process. However, this grid is not readily transferable to a process that uses localised irradiation (e.g. laser sintering).

It is the object of the invention to propose a solution which is as simple as possible and yet effective for a manufacturing device for the additive manufacturing of three-dimensional components by layer-by-layer application by at least one coating unit and locally selective solidification of a build-up material by at least one irradiation unit, wherein the removal of the three-dimensional structure (and/or of non-solidified powder) should be as simple as possible and feasible with comparatively little effort. Furthermore, it is the object of the invention to propose a corresponding manufacturing method as well as a corresponding system.

Under a local selective solidification by means of an irradiation unit are to be understood in particular processes in which the irradiation unit irradiates individual locations in a focused manner. Preferably, this comprises the irradiation and, possibly, scanning with laser carriers from one or a plurality of laser(s) or laser diode(s).

This object is solved in particular by the features of claim 1.

In particular, the object is solved by a manufacturing device for additive manufacturing, preferably of metallic and/or ceramic, three-dimensional components, preferably by layer-by-layer application by at least one coating unit (as a part of the manufacturing device) and locally selective solidification of a build-up material, preferably by at least one irradiation unit (as a part of the manufacturing device), comprising a build-up platform, wherein the build-up platform has an upper section with at least one (optionally non-closable) upper opening, on which the component can be (in particular directly) build up, as well as a lower section with at least one closable lower opening.

One idea of the invention is to provide a building platform which has at least one upper opening in an upper section (on which the three-dimensional component is build up) and at least one closable lower opening in a lower section. Between the upper and lower openings there is preferably a holding are area for holding powder (with a holding volume of, for example, at least 1 cm³ or at least 10 cm³ or at least 100 cm³ and/or at most 25000 cm³, optionally at most 5000 cm³). In this way, removal of the three-dimensional component can be carried out in a simple and effective manner (without having to simultaneously remove larger quantities of powder, as for example in WO 2014 044 705 A1).

According to a further aspect of the present invention (which is in principle independent, but preferably combinable with the above aspect), a manufacturing device (in particular of the above type) is proposed for the above object, for the additive manufacturing of three-dimensional components, preferably by layer-by-layer application by at least one coating unit and locally selective solidification of a build-up material, preferably by at least one irradiation unit, comprising a building platform, a carrier for the building platform, as well as a building shaft in which the carrier is relatively variable in height, wherein the carrier has a supporting device which is partly arranged outside the building shaft and moves in a recess of a building shaft wall when the carrier is relatively varied in height (for example in relation to an e.g. stationary building shaft is moved up or down not), wherein the recess above and below the supporting device is coverable (or covered) by a cover, in particular comprising or formed by a cover strip (and preferably in any position of the carrier or building platform, in particular relative to the building shaft).

A preferred idea of the aspect of the previous paragraph is that by the carrier or the supporting device an adjustment or change of the height of the carrier or the building platform is enabled in a simple manner. By the fact that a recess, which is basically necessary in the present context, is covered both above and below the supporting device, a removal of (for example excess) powder downwards can be made possible in a simple manner without the powder (unintentionally) leaving the building shaft through such a recess. In particular, in combination with the above aspect concerning the upper or lower opening(s) of the building platform, it is thereby achieved that an effective discharging of the powder can be enabled in a simple manner and, in particular, an effective and simple removal of the manufactured three-dimensional component can be enabled.

In particular, the three-dimensional component can be built up directly on the upper section of the building platform (e.g. a corresponding plate with at least one upper opening) (or is built up directly there in the method according to the invention), that is in particular without there being a distance, for example due to an underlying powder layer, between the underside of the object to be built up and the upper side of the building platform.

There may be at least two or at least four or at least 10 and/or at most 100 or at most 50 or at most 20 upper (possibly non-closable) openings.

In one embodiment, there is only one lower opening (in particular central or arranged in an edge region), but there may also be at least two or at least four and/or at most 10 lower openings in alternative embodiments. An opening is preferably understood to be a contiguous surface section (free of material).

The upper section is preferably flat (or planar) (apart from the at least one upper opening).

The carrier may have the supporting device as an integral part. It is also possible that the carrier comprises a carrier element (for example movable within the building shaft) which is connected to and/or supported by the supporting device, wherein the latter preferably is arranged at least partially outside the building shaft. The carrier may also comprise (or be formed by) only the supporting device. The carrier and/or the carrier element and/or the supporting device may be formed one-piece or multipart. In particular, the carrier may comprise at least two parts, one of which is arranged (at least predominantly) inside the building shaft and the other (at least predominantly) outside the building shaft (wherein predominantly preferably refers to a corresponding predominant weight share).

In a specific embodiment, the upper section comprises or is formed by a plate (in particular flat at least on the upper side, possibly also on the lower side).

Alternatively or additionally, the lower section may be formed by or comprise a cone or truncated cone. Preferably, an opening (in particular exactly one) is arranged in the centre of the cone or truncated cone.

The lower section may extend to heights of the upper section.

A centre of gravity of the lower section is preferably at least 5 cm or at least 10 cm below a centre of gravity of the upper section.

The lower section preferably does not comprise a surface on which the component can be built-up or is built-up. Alternatively, however, it would be conceivable for the lower portion to form at least a certain part of such a surface (but preferably less than 50% by area, more preferably less than 20% by area or less than 5% by area).

Alternatively or additionally, the carrier may comprise a cone or truncated cone, wherein preferably an opening is arranged in the centre of the cone or truncated cone. In such solutions, a reception of excess powder (passing through the at least one upper opening) can be performed in a simple manner, whereby in particular in the case of a cone or truncated cone shape, a further discharging of the powder (downwards, through the building platform and possibly the carrier) can be performed if required.

In a specific embodiment, the building platform may comprise two parts, namely an upper plate and a section, in particular in a cone shape or truncated cone shape, supporting or holding the upper plate.

In embodiments, the carrier (in particular the carrier element) may comprise a closing device for closing an opening of the lower section of the building platform (and/or vice versa, in particular in the sense that the building platform or its lower section comprises a closing device for closing an opening of the carrier; optionally, the carrier and the building platform may also comprise such structures corresponding to each other that, by bringing them together, a closing of a respective opening, in particular an opening of the building platform or an opening of the support, can take place).

In embodiments, the upper section comprises at least one, or at least two, and/or at most 50, preferably at most 10 openings. Alternatively or additionally, the lower section comprises exactly one or more than one opening and/or at most 10, optionally at most four, openings.

In one embodiment, at least one opening of the upper section is arcuate, preferably circular arcuate, wherein preferably a plurality of openings form a circle which is interrupted by at least one web, preferably at least two or at least four webs, wherein optionally a plurality of such circles are formed (in particular concentrically to each other). In such a way, particularly preferably a component that is ring-shaped at least in the area of a bottom surface or a first layer can be printed. Possibly, several rings can result if different rotationally symmetrical components are manufactured one inside the other or the component consists of several rings.

The upper section (especially in combination with the possibility for arcuate openings explained in the previous paragraph) can, for example, be round (alternatively oval, especially elliptical).

It is also conceivable that at least one opening (or several adjacent openings together) runs (run) straight, for example rectangular (possibly also square). In embodiments, the (possibly straight running) opening(s) may be comparatively elongated (for example have a length that is at least 2 times or at least 5 times as large as a width of the opening).

Alternatively or additionally, the upper section of the building platform may also have a polygonal, in particular quadrangular (according to embodiment rectangular or square) shape.

In particular, a component with an angular (e.g. rectangular) contact surface can be manufactured on a corresponding angular (rectangular) frame.

A component with a disc-shaped cross-section could possibly be built on a disc.

The upper section (e.g. disc or circle or rectangle) can possibly be so large that only at one edge at least one upper opening is present. In this case, possibly not all of the powder can flow out. A part could then possibly be removed together with the three-dimensional object (for example, via a corresponding cartridge).

In principle, any (also non-regular geometric) shapes are possible for the upper section of the building platform.

Preferably, however, the upper section is designed in such a way that a large part of the (excess) powder (i.e. at least 50% by weight, preferably at least 80% by weight or at least 95% by weight of the excess powder) can flow downwards through a (sufficiently large) opening. The corresponding opening(s) may optionally be anywhere that does not need to be manufactured in the first layer.

In embodiments, at least one opening of the upper section has a cross-sectional area of at least 1.0 mm², preferably of at least 1.0 cm², optionally at least 10 cm² or even at least 20 cm² and/or at most 500 cm².

The manufacturing device preferably comprises a (in particular gas-sealable) container (cartridge), the lower end of which is preferably closable by the building platform and which (particularly preferably) is removable from the manufacturing device. Such a container is known at least in principle from WO 2014/044705 A1.

However, in combination with the upper as well as the lower opening, it is possible in the present case that the component is transferable, for example, into the container (the cartridge) without removing a comparatively large amount of excess material (which can be discharged beforehand, if necessary). The container in which the component(s) is then located is then comparatively light, which simplifies removal and further transportation (and/or storage) of the container.

In embodiments, a receiving device is provided, in particular around the building shaft and/or at least in sections below a section, preferably flange section, of the building shaft, to receive excess build-up material. For this purpose, at least one (or several) opening(s) may be provided, which are arranged for example (e.g. in said flange section) in such a way that a material displaced by the pushing unit can fall through the respective opening and then be collected (further down) if necessary.

A/the building shaft can be closed or lockable at its lower end in such a way that build-up material discharged through the at least one opening of the lower section is receivable in the building shaft, wherein the build-up material received in this way can be cooled, if necessary, by means of a, in particular active, cooling device, and/or can be combined with a (the) received build-up material (or can be collected and/or removed separately from the latter). By means of such measures, portions of the build-up material that remain during the manufacturing process, be it, for example, in that a pusher unit (coating unit) pushes a portion of the powder beyond a build-up area and/or be it in that powder (for example at the end of the build-up process) is discharged downwards, can be collected and can possibly be removed, in a simple manner.

Received build-up material (in particular as previously described) is preferably returnable to the manufacturing process (or the manufacturing device or a corresponding installation comprising the manufacturing device configured accordingly).

The recess of (or in) the building shaft wall preferably comprises or is formed by a slit.

The recess, in particular the slit preferably extends over a (vertical) length or height which corresponds at least approximately to a travel path of the carrier relative to the building shaft (possibly corresponding to at most 1.5 times or at most 1.2 times of such a travel path) and/or over at least 50% of a height of the building shaft.

The cover (for the recess) may preferably comprise a band which is connected to the carrier (in particular the supporting device). The band may be formed circumferentially or have two ends which are, for example, connected to the supporting device.

The above-mentioned object is further solved by a manufacturing method for additive manufacturing of at least one three-dimensional component by layer-by-layer application (preferably by at least one coating unit) and preferably locally selective solidification of a build-up material (preferably by at least one irradiation unit), using the above manufacturing device, comprising the steps:
a) feeding of build-up material onto the building platform until an uppermost layer of the build-up material is at least (in particular exactly) at the level of an upper surface of the upper section, in particular such that a space between the upper and lower sections is filled,
b) building up the component, and
c) opening of the lower section for discharging of remaining build-up material.

Preferably, after step c), the building platform is connected to a (the) container, which is preferably closed by the building platform (or its lower section with the closable lower opening(s)) at its lower end.

In embodiments, in step b), excess material may be received in a receiving device and optionally combined with the material discharged in step c) (or at least partially, optionally completely, separately received and/or removed from the latter).

Preferably, at least one upper opening and a starting layer are coordinated with each other upon building up the at least one component, in particular in such a way that upon building up the at least one component the starting layer is not arranged directly (in the vertical direction) above the at least one upper opening. In embodiments, at least a section of the starting layer of at least one component may be further away from a surface centre of the building platform than at least a section of an upper opening. Alternatively or additionally, at least a section of a starting layer of at least one component may be less distant from a surface centre of the building platform than at least a section of an upper opening. By a surface centre of the upper section is preferably meant a centre of area (e.g. centre of a circle in the case of a circular shape).

As an independent (but preferably further defining) process aspect, for solving the above object, a manufacturing method (in particular of the above type) is proposed for the additive manufacturing of at least one three-dimensional component preferably by layer-by-layer application by at least one coating unit and locally selective solidification of a build-up material preferably by at least one irradiation unit, using a manufacturing device of the above type (in particular according to the second aspect), comprising the following steps: building up the component, as well as at least temporarily receiving build-up material, which is conveyed beyond the building platform during the coating, and/or of build-up material, which is removed after the manufacturing process, at least partially in (or within) the building shaft(s).

The above object is further in particular solved by a system comprising the above manufacturing device, as well as the build-up material, in particular for carrying out the above manufacturing method, wherein the build-up material preferably comprises a metal component and/or a ceramic component.

In principle, the manufacturing device is configured to process a build-up material comprising a metal component and/or a ceramic component. Preferably, the build-up material comprises at least 50% by weight, further preferably at least 80% by weight, still further preferably at least 90% by weight of a metal and/or a ceramic.

The grain size or particle size can possibly be determined by laser diffraction methods (in particular by means of laser diffraction measurement according to ISO 13320 or ASTM B822). Alternatively or additionally, the particle sizes can be determined by measuring (for example by means of a microscope) and/or with dynamic image analysis (preferably according to ISO 13322-2, if necessary by means of the CAMSIZER® XT of Retsch Technology GmbH). If the particle size is determined from a 2-dimensional image (e.g. of a microscope, especially an electron microscope), preferably the respective diameter (maximum diameter or equivalent diameter) which results from the 2-dimensional image is used.

The (mean) grain size or particle size of the individual particles of the build-up material is preferably a d50 particle size. In the case of the mean particle size, the indication d (numerical value) stands for the number of particles (in mass and/or volume percent) that are smaller than or equal to the indicated grain size or particle size (i.e. for a d50 of 50 μm, 50% of the particles have a size of ≤ 50 μm). The particle size is preferably determined by the diameter of a single particle, which in turn possibly may be the respective maximum diameter (=supremum of all distances between each two points of the particle) or a sieve diameter or an (in particular volume-related) equivalent sphere diameter.

The build-up material preferably has a (mean) particle size of at least 50 nm, further preferably at least 200 nm and/or at most 300 μm, optionally at most 80 μm.

The individual particles of the build-up material can be (at least approximately) the same size or there can be a particle size distribution.

Preferably, the build-up material is a material having a melting temperature of at least 300° C., preferably at least 500° C., optionally at least 800° C. and/or up to 1000° C., or optionally more.

The (pulverulent) build-up material preferably comprises at least one metal and/or at least one ceramic material and/or at least one plastic, preferably polymer. For example, the metal may comprise aluminium, titanium, nickel, iron, tungsten, molybdenum and/or alloys thereof. Particularly preferably, the (pulverulent) build-up material comprises copper. Preferably, the build-up material comprises at least 10% by weight, further preferably 50% by weight, still further preferably at least 80% by weight, still further preferably at least 99% by weight or 99.99% by weight or 100% by weight of one (in particular one of the above mentioned) or at least one (in particular several of the above mentioned) metal(s).

Preferably, the building platform is designed in such a way that unsolidified build-up material can flow down through (at least one upper) opening of the building platform and can be received in a volume (e.g. container) delimited by the building platform itself, which volume in turn is closable (downwards). The building platform may be filled with powder at the start of a build job, such that the respective upper opening (or the respective upper openings) is (are) sealed by the powder and (together with the sealing powder) form a build plane. However, the component (or the starting layer to produce it) is possibly only formed (directly) on the areas of the building platform that are not formed by an opening (even if that opening is filled by powder at some point). After completion of the build job, the (respective) lower opening in the volume (receiving container) of the building platform can be opened and thus the (unsolidified) build-up material can escape.

The building platform (in particular a receiving container formed by it) is preferably designed in such a way that excess build-up material can be pushed into the inner volume of the building platform (the receiving container) by a pusher (or a pushing unit). The (lower) opening preferably also allows build-up material to escape from this area (if required).

In embodiments, the manufacturing device comprises a transport container (transport cartridge), which further preferably comprises or is connectable to the building platform. The building platform may optionally be picked up by the carrier or moved to an irradiation area. There, if necessary, powder can be added and a solidification of the object can be started. Once the building up of the component (or the several components) is completed, the building platform can be placed under the transport cartridge. Next, possibly unsolidified powder can be released downwards (e.g. into the carrier) and the object (together with the building platform) can be lifted into the transport container (transport cartridge). The transport cartridge can now be removed again if necessary, whereby the powder remains in the manufacturing device (e.g. at least initially in the carrier).

A new transport container (transport cartridge) can be inserted into the manufacturing device if necessary. A possible old powder from a previous build job can be recycled and fed into a current build job. Alternatively, or (at least partially) additionally, it can be transferred to an external powder treatment facility and fed to the build job from there, if applicable.

The upper section and the lower section of the building platform can be structurally separated from each other, in particular connected to each other in such a way that they can also be removed from each other. For example, an upper section (depending on the application) may also be connected to a correspondingly adapted lower section.

The upper section and the lower section of the building platform may form a common (integrally connected) unit and, in particular, may be non-destructively separable from each other.

Further embodiments of the invention will be apparent from the dependent claims.

In the following, the invention will be described with reference to execution examples, which will be explained in more detail with reference to the figures.

Hereby show:

FIG. 1 a schematic illustration, partially reproduced as a cross-section, of a manufacturing device for the layer-by-layer construction of a three-dimensional object;

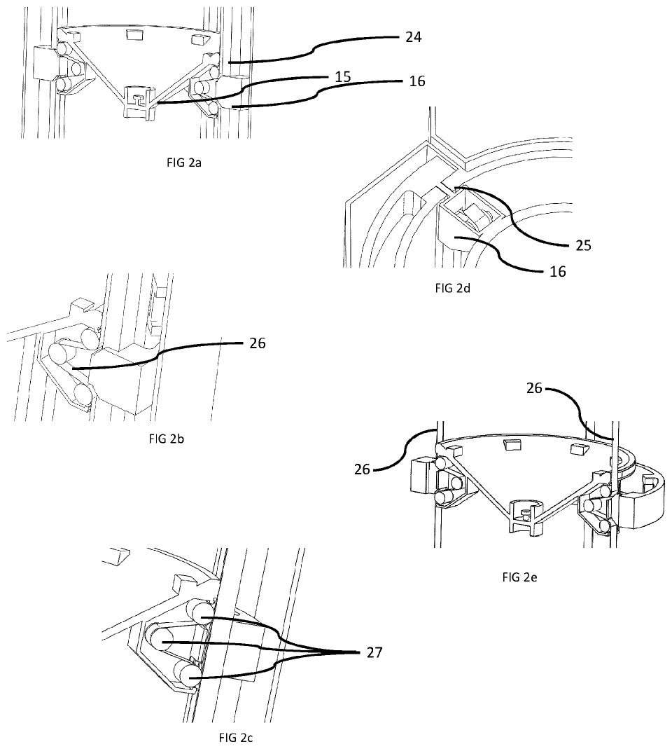

FIG. 2a a section of the manufacturing device according to FIG. 1 in the area of a building shaft;

FIG. 2b a section of FIG. 2a at a different angle;

FIG. 2c a section of FIG. 2a at a different angle;

FIG. 2d a horizontal cut of the section of FIG. 2a (in an oblique view);

FIG. 2e an oblique view of the section of FIG. 2a without wall of a building shaft;

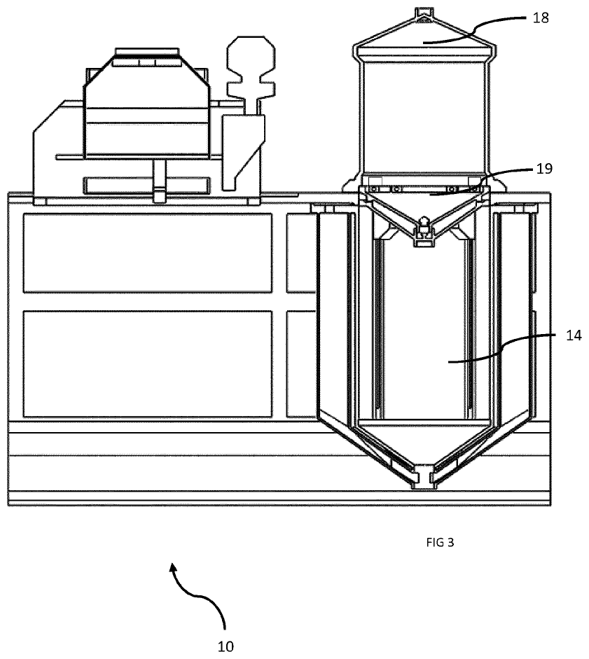

FIG. 3 the embodiment according to FIG. 1 in a different position of a building platform;

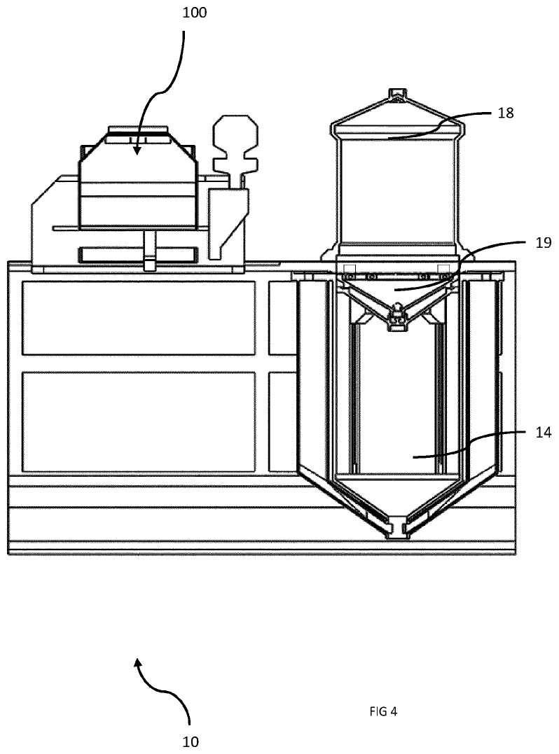

FIG. 4 the embodiment according to FIG. 1 in a further position;

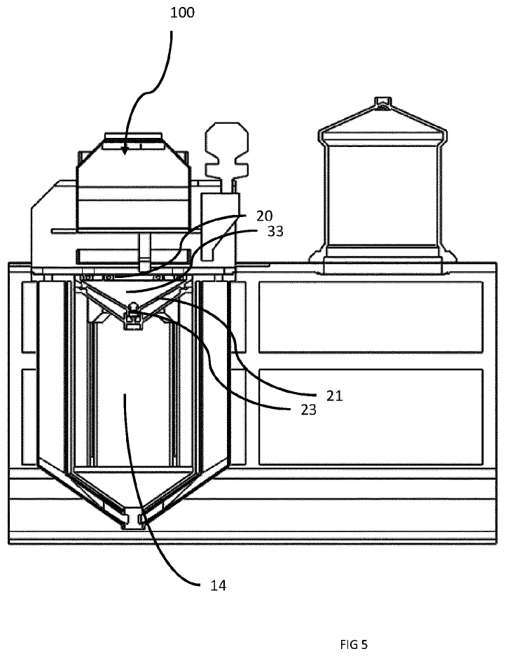

FIG. 5 the embodiment according to FIG. 1 in a further position;

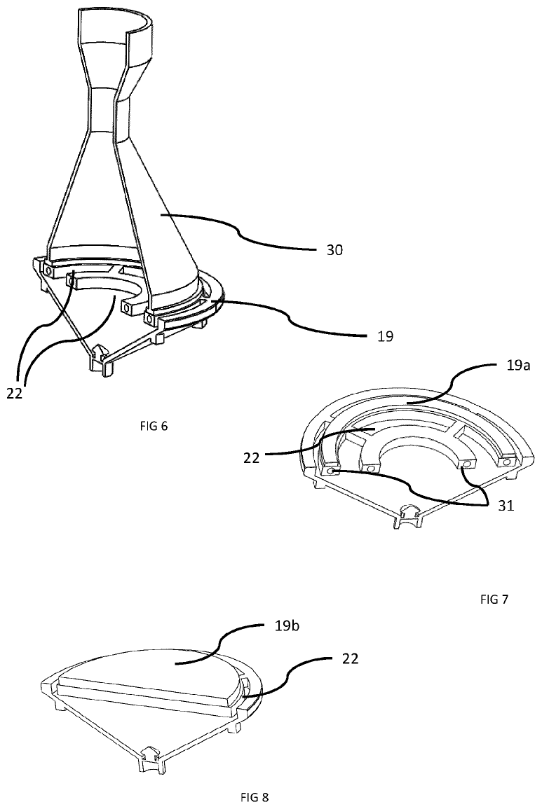

FIG. 6 an oblique view of an embodiment of a building platform with a component located thereon (in excerpts);

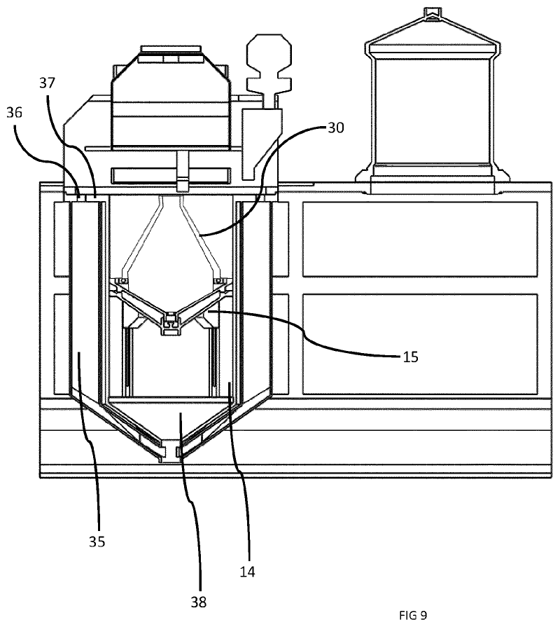

FIG. 7 the building platform according to FIG. 6, at least predominantly without a component;

FIG. 8 an alternative embodiment of a building platform with a component (at least in excerpts);

FIG. 9 the embodiment according to FIG. 1 in a further position;

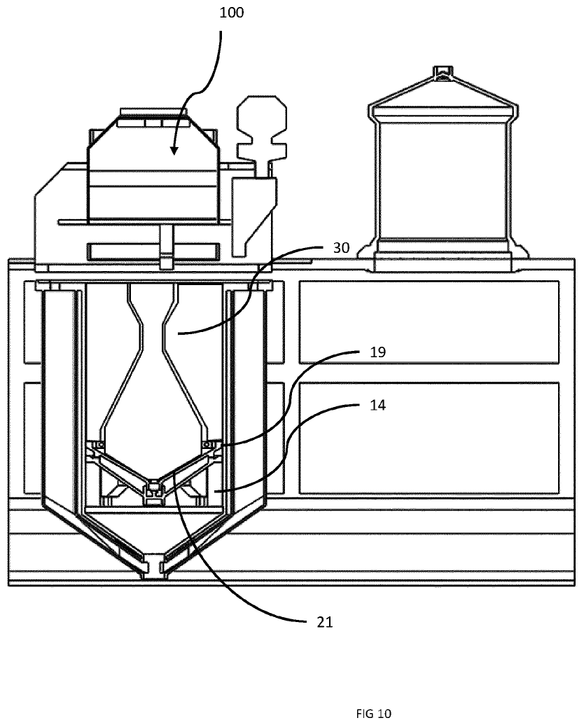

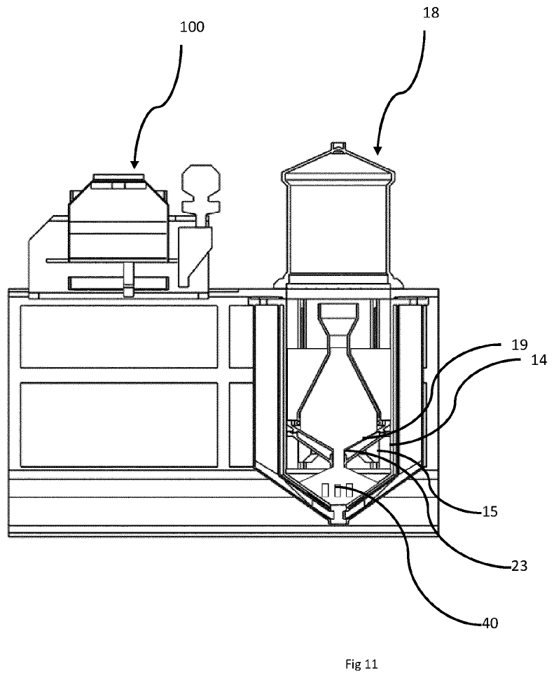

FIG. 10 the embodiment according to FIG. 1 in a further position;

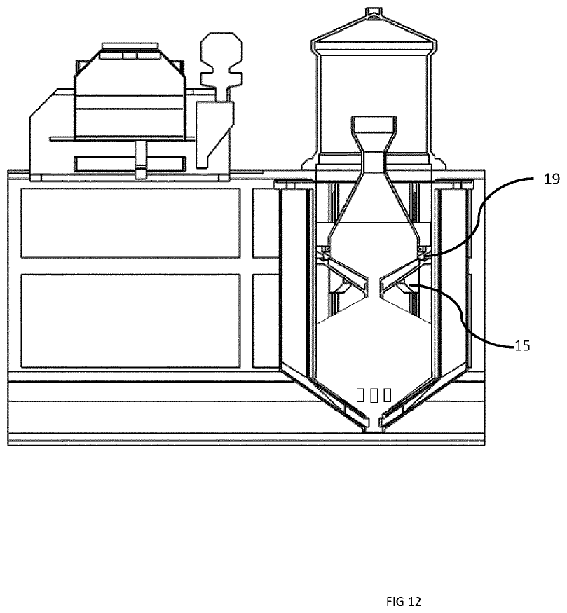

FIG. 11 the embodiment according to FIG. 1 in a further position;

FIG. 12 the embodiment according to FIG. 1 in a further position;

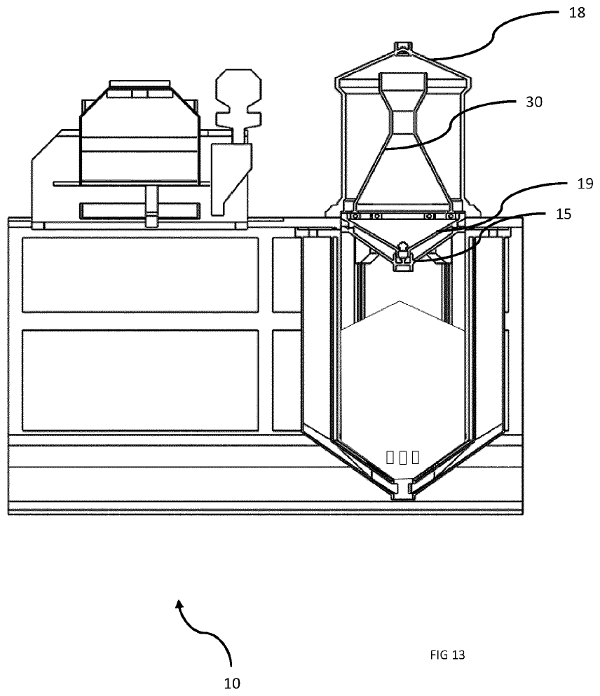

FIG. 13 the embodiment according to FIG. 1 in a further position;

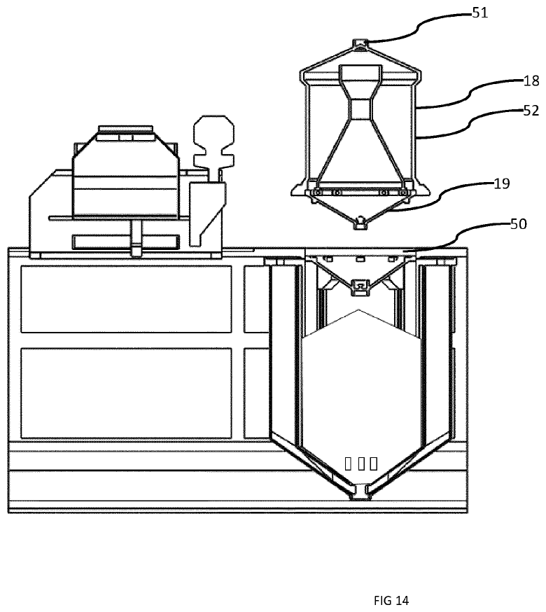

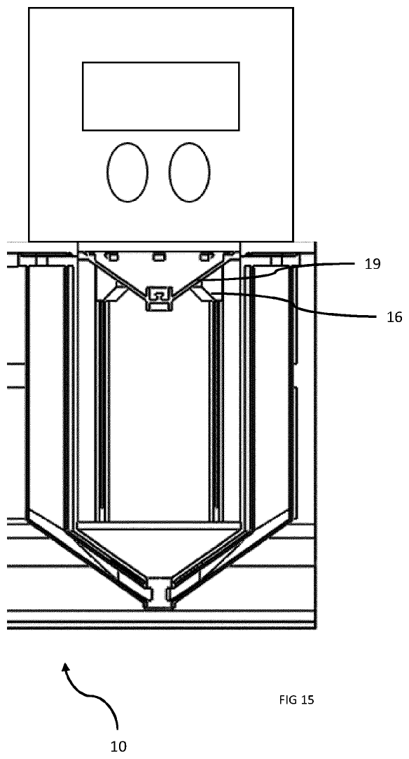

FIG. 14 the embodiment according to FIG. 1 in a further position;

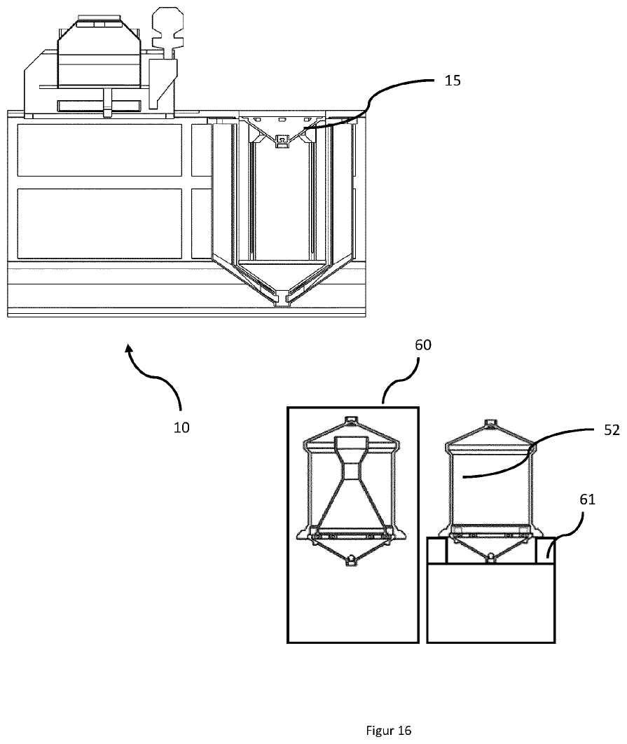

FIG. 15 an alternative embodiment of the manufacturing device;

FIG. 16 the embodiment of the manufacturing device according to FIG. 1 with further devices;

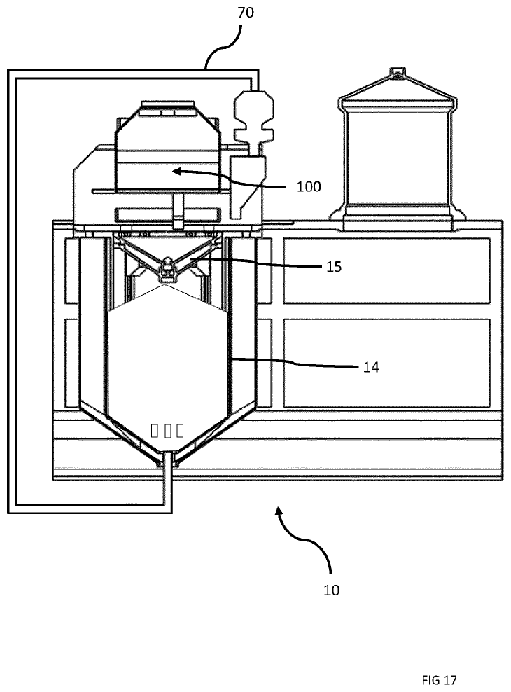

FIG. 17 the embodiment of the manufacturing device according to FIG. 1 with further devices;

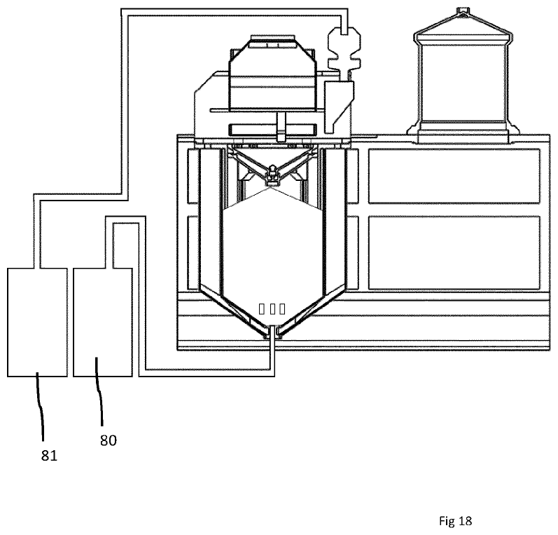

FIG. 18 the embodiment of the manufacturing device according to FIG. 1 with further devices;

In the following description, the same reference numerals are used for same parts and parts with the same effect.

FIG. 1 shows an embodiment of a manufacturing device 10, for example a laser sintering device.

The manufacturing device 10 comprises an irradiation unit 11 and a coating unit 12 (for example comprising a pusher and a device for applying powder material layer by layer), which are components of a corresponding irradiation and coating unit 100. The (pulverulent) build-up material may be applied by a (for example funnel-shaped or hopper-like) feeding device 13 and then optionally distributed layer by layer by a pusher (not shown in detail). Furthermore, the manufacturing device 10 has a building shaft 14, in which a carrier 15 is (vertically) movable. The carrier 15 has a supporting device 16 and a carrier element 17. The carrier element 17 has a cone shape or truncated cone shape.

Above the carrier 17 (in the position according to FIG. 1) is a transport container 18, which can be closed (in particular gas-tight) at the bottom by a building platform 19 with an upper section 20 and a lower section 21. Specifically, the upper section 20 has at least one upper opening 22 and the lower section 21 has at least (or here exactly) one lower opening 23. Upper section 20 and lower section 21 are here formed as separate components (but connected to each other). However, upper section 20 and lower section 21 can also be formed by a common component (e.g. not detachable from each other).

The at least one upper opening 22 (or the several upper openings 22) are not closable (but this may alternatively be the case). The lower opening 23 is closable (in particular gas-tight). Preferably, by this means the transport container 18 (with attached building platform 19) can be closed in a gas-tight manner as a whole.

The carrier 17 can be moved (in height) within the building shaft 14, which is further explained with reference to FIGS. 2a-2e.

In FIG. 2a first the carrier 15 including supporting device 16 as well as a building shaft wall 24 is illustrated. As can be seen, the supporting device 16 and thus the carrier 15 penetrates the building shaft wall 24. Specifically, at least one (or, according to the embodiment, several) slit(s) 25 is/are provided in the building shaft wall (see FIG. 1) within which the supporting device 16 can be moved. These slits 25 generally each form a (elongated) recess through which (without further measures) powder could pass into this area through the building shaft wall 24. In order to prevent (or at least reduce) this, the manufacturing device 10 has a belt 26 (cf. FIGS. 2b, 2c and 2e) which is arranged both above as well as below the supporting device 16 (and at every possible height of the supporting device 16). The belt can be deflected at the supporting device 16 via (here three) deflection devices, for example in the form of cylinders 27. By this it is made possible that the supporting device (and thus the carrier 15) can be moved in such a way that the slit 25 remains covered by the belt 26 (both above as well as below the supporting device 16). By this it can be prevented in an easy manner (or at least reduced accordingly) that powder penetrates through the shaft wall. In particular, an area below the supporting device 16 can thus also be used to receive and retain build-up material.

FIG. 3 shows the manufacturing device 10 according to FIG. 1 in a further position, namely in a position in which the unit comprising the transport container 18 and the building platform 19 is arranged (or placed) above the building shaft 14. In this state, however, the transport container 18 and the building platform 19 are still connected to each other.

In a further position shown in FIG. 4, the building platform 19 is detached from the transport container 18 and in a position in which a layer-by-layer application of build-up material (and the building up of an object) can take place. To perform a corresponding operation, the irradiation and coating unit 100 (see FIG. 5) is moved to a corresponding position (above the building shaft 14). Before that (see also FIG. 5), the transport container 18 (without building platform 19) was removed from a position above the building shaft 14.

FIG. 6 shows the building platform 19 in the embodiment according to FIG. 1 with a (partially shown) component 30 (which is formed rotationally symmetrical here). Specifically, the building platform or its upper section 20 has upper openings 22, wherein the upper openings 22 in this case comprise several arcuate openings and a central circular opening (other geometric shapes are conceivable). In other words (at least in the embodiment according to FIG. 6), several openings 22 are proposed, which form several (here two) annular structures, wherein the annular structures are interrupted by corresponding webs. Furthermore, a central (circular) opening 22 is provided.

FIG. 7 shows the building platform 19 according to FIG. 6 and a lowermost section of the component 30 (or a differently shaped component, e.g. in the form of a flat ring). Furthermore, according to FIGS. 6 and 7, at least one channel 31 (preferably several channels 31) is provided, for example for passing a cooling and/or heating fluid.

In the embodiment according to FIG. 1, other building platforms 19 can also be used, for example a building platform according to FIG. 8. There, openings 22 (comparatively close to an edge of the building platform) are provided which form a common ring structure (interrupted by webs). Otherwise there are no further openings. By this, particularly preferably a disc-shaped component 30 (or generally a component, with a disc-shaped lowermost coating layer) can be produced.

In the position according to FIG. 5, a manufacturing process can be carried out. For this purpose, a volume 33 between an upper side of the upper section 20 of the building platform 19 and the lower opening 23 of the lower section 21 (here in the closed state) is first filled with powder. By this, a (plane) surface is formed, which is partly formed by an upper side of solid structures of the upper section 20 and partly by a build-up material, the surface of which is flush with this upper side.

Preferably, however, the structures of the component are only applied to the (solid) upper side of the upper section 20 (layer by layer by coating and corresponding irradiation).

FIG. 9 then shows the manufacturing process at an advanced stage. In particular, the component 30 also visible in FIG. 6 has already been at least partially (or even in large part) manufactured. According to FIGS. 5 and 9, for this the support 15 has been successively moved downwards within the building shaft 14 so that layer after layer can be applied and (locally) solidified.

In summary, an area within the building platform 19 is initially filled with powder until a level powder bed is formed that is flush with a surface of the building platform 19. Such a filling process can be carried out via a coater arm. Alternatively or additionally, an (independent) metering unit would also be conceivable.

This is then followed by the building process.

As can also be seen in FIG. 9, a receiving area 35 is arranged around the building shaft 14. In the receiving area 35, build-up material that is conveyed beyond a build-up area (or the building platform 19) can be received during the coating or application of the build-up material. Specifically, the build-up material can pass (fall) through openings 36. The one or more opening(s) 36 is (are) preferably formed by a flange section 37 at an upper end of the building shaft 14.

In this respect, the receiving area 35 preferably forms an overflow container. If necessary, build-up material received there can (preferably at a later time) be combined with a receiving area 38 below the carrier 15 (alternatively, the respective material can also be removed separately, for example sucked off).

In FIG. 10, a further position of the manufacturing device 10 according to FIG. 1 is shown, specifically at a time when the build-up process for the component 30 has just been completed. Here, the irradiation and coating unit 100 is still located above the building shaft 14. A volume between an upper end of the building shaft and the lower section 21 of the building platform 19 is here completely filled with build-up material (either in solidified form or formed by the component 30 or still as excess powder).

FIG. 11 now shows a position similar to FIG. 10, but the irradiation and coating unit 100 has been removed from an area above the building shaft 14 and a (possibly further) transport container 18 has now been arranged (placed) there. Furthermore, it can be seen in FIG. 11 that the excess powder is now received through the lower opening 23 of the building platform 19 as well as and through a therewith corresponding opening in the carrier 14 in a receiving area below the carrier 15, but inside the building shaft 14. In this area, a cooling device 40 is provided in order to appropriately cool the powder (to counteract a possibly problematic heat generation). The cooling device may comprise at least one fluid channel for passing a cooling medium and/or at least one electrical cooling element (e.g. Peltier element). The optional cooling medium may possibly be cooled by an active cooling device (for example comprising a heat pump). Such an active component of the cooling device is preferably arranged outside the building shaft 14.

Due to the belt 26 shown e.g. in FIG. 2e, this (lower) area of the building shaft can be used in a simple manner as a receiving area for the build-up material.

FIG. 12 shows a further position of the manufacturing device, in which (compared to FIG. 11) the carrier 15 or the building platform 19 has been moved further (relatively seen) upwards, so that even more build-up material is now available in an area below the carrier 15.

The build-up material can flow off downwards, in particular by gravity (optionally, it would also be conceivable to support a flow off by corresponding overpressure above the building platform 19 and/or underpressure below the building platform 19). Alternatively or additionally, it may be advantageous to vibrate (or fluidise) the building platform 19 and/or the carrier 15 in order to improve the flow behaviour of the powder.

In any case, it is advantageous that the build-up material is or at least can be stored in the building shaft 14 that previously served as a boundary for the build-up material during the build job.

The build material may always flow off through one or several openings, which are located within a boundary of a building platform seal (wherein this seal may possibly be located in the carrier 15) when discharging. The building platform 19 or the carrier 15 is therefore not (completely) pulled out of the bottom of the building shaft 14, so that also no build-up material can flow off laterally (e.g. outside the seal). The build-up material always flows off inside such a seal. Also, the powder is not removed through (lateral) openings in the shaft wall. All in all, excess build-up material can thus be removed, in particular discharged, in a simple manner.

The above-mentioned seal against a shaft wall or shaft inner wall can preferably be arranged circumferentially around an outer edge of the building platform 19 (for example, in the embodiment according to FIG. 6, defined by an upper outer edge of the lower section 21).

FIG. 13 shows a state of the manufacturing device 10 in which all of the build-up material has been discharged, namely into an area below the building platform 19 or the carrier 15. Furthermore, in this state the built-up component 30 is arranged inside the transport container 18, wherein this transport container is closed at the bottom by the building platform 19.

FIG. 14 schematically shows a position in which the unit comprising the transport container 18 and the building platform 19 has been removed from the building shaft 14 or carrier 15. In this position, the building shaft 14 can optionally be closed by a closing device 50 (e.g. plate), if necessary gas-tight.

The (container) unit comprising the transport container 18 and the building platform 19 is subsequently also referred to as cartridge 52. This can preferably be sealed to the outside, for example under inert gas (or with inert gas taken up). In addition to the closable lower opening 23, which is formed by the building platform 19, the cartridge 52 may have a further opening 51 (in particular at an upper section of the cartridge or transport container 18), for example for removing and/or supplying gas (for example supplying inert gas).

The removal of the component 30 within the cartridge 52 (comprising the transport container 18 and the building platform 19) under protective gas/inert gas is only optional. The general approach to removing the component can in principle also be combined with a classic glove-box solution, as shown in FIG. 15. In this case, the carrier element 17 of the carrier 15 or (depending on the point of view) the lower section 21 of the building platform can then be omitted. In any case, the building platform 19 can also be moved here by a supporting device 16 (which in this case defines the carrier).

However, in the variant shown, for example, in FIGS. 1 and 14, the building platform 19 can be separated from the carrier 15 so that the cartridge 52 (and possibly also the building shaft 14) can be kept gas-tight when the cartridge 52 or building platform 19 is separated from the building shaft 14.

One advantage is that upon re-docking of the cartridge 52 (or a new cartridge), a contamination of an atmosphere inside the building shaft 14 is comparatively low, as only a comparatively small volume of the above atmosphere can enter the building shaft 14 (for example in the area of a valve).

In the embodiment according to FIGS. 1 and 14 (for example), the build-up material (irrespective of how a geometry of the component to be produced is) between building shaft 14 and component 30 can be removed in advance, if necessary, so that a comparatively easy transfer (pushing-over) of the component into the cartridge 52 is made possible. If the build-up material is not removed in advance, a build-up material column would remain in the cartridge or would have to be transferred (pushed over) into the same while the same is always in contact with the respective wall. This could then lead to problems with regard to sealing and other functioning.

In general, however, it is conceivable (cf. FIG. 15) that a division into two parts into building platform 19 and support 15 is not necessary. A removal procedure can otherwise be carried out as described above (apart from the procedure associated with this division into two parts).

FIG. 16 shows the manufacturing device 10 according to FIG. 1, as well as a cleaning device 60 and a storage device 61. Specifically, the cartridge 52 can be transferred into the cleaning device 60 and then cleaned by (or at least assisted by) rotation. After the (optional) cleaning process, the cartridge can then be arranged in or on a storage device 61.

FIG. 17 again shows the embodiment according to FIG. 1, but with an (optional) return device 70. The return device 70 comprises a transport mechanism, whereby build-up material that is removed (in particular at a lower opening thereof) from the building shaft 14 is returned to the coating and irradiation unit 100. This may be done during an ongoing build job or manufacturing operation, and/or after or before a subsequent manufacturing operation.

In particular, while the manufacturing operation is in progress, the build-up material may still be below the carrier 15 but within the building shaft 14. An (optional) cooling and conveying-off of the build-up material of a previous manufacturing process can (but does not have to) take place in parallel with the manufacturing process of the subsequent manufacturing process.

Alternatively or additionally (see FIG. 18), a build-up material storage device (container) 80 (located outside the building shaft or manufacturing device 10) may also be provided, in which powder collected from the building shaft 14 and/or the receiving area 35 is (externally) collected. From the storage device 80 or (optionally) a further storage device 81, build-up material can then in turn be fed to the process, specifically to the coating and irradiation unit.

At this point, it should be pointed out that all of the parts described above, considered on their own and in any combination, in particular the details shown in the drawings, are claimed to be essential to the invention. Modifications hereof are familiar to the skilled person.

### REFERENCE SIGNS

10 manufacturing device
11 irradiation unit
12 coating unit
13 feeding device
14 building shaft
15 carrier
16 supporting device
17 carrier element
18 transport container
19 building platform
20 upper section
21 lower section
22 upper opening
23 lower opening
24 building shaft wall
25 slit
26 belt
27 deflection device
30 component
31 duct
33 volume
35 receiving area
36 opening
37 flange section
38 receiving area
40 cooling device
50 closing device
51 opening
52 cartridge
60 cleaning device
61 storage device
70 return device
80 storage device
81 storage device
100 irradiation and coating unit

1. Manufacturing device for additive manufacturing, three-dimensional components by layer-by-layer application by at least one coating unit and locally selective solidification of a build-up material by at least one irradiation unit, comprising a building platform unit, wherein the building platform unit has an upper section with at least one upper opening, which faces the component during the manufacturing process, and a lower section with at least one closable lower opening.

2. Manufacturing device, according to claim 1, for additive manufacturing of three-dimensional components by layer-by-layer application by at least one coating unit and locally selective solidification of a build-up material by at least one irradiation unit, comprising a building platform unit, a carrier for the building platform unit, and a building shaft, in which the carrier is relatively variable in height, wherein the carrier has a supporting device and is arranged partially outside the building shaft and moves in a recess of a building shaft wall when the carrier is relatively changed in height, wherein the recess can be covered above and below the supporting device by a cover comprising a cover strip or formed by such a cover strip.

3. Manufacturing device-according to claim 1, wherein the upper section is or comprises a plate and/or the lower section has a pyramid shape or a cone or truncated cone shape, wherein an opening is arranged in the center of the tapering shape, and/or the carrier has a pyramid shape or a cone or truncated cone shape, wherein an opening is arranged in the center of the tapering shape.

4. Manufacturing device according to claim 1, wherein the carrier comprises a closing device for closing an opening of the lower section, and/or vice versa.

5. Manufacturing device according to claim 1 wherein the upper section has at least two, and/or at most 10 openings, and/or the lower section has exactly one or more than one opening and/or at most four openings.

6. Manufacturing device according to claim 1, wherein at least one opening of the upper section is circular arcuate, wherein several openings form a circle which is interrupted with at least four webs, wherein several such circles are arranged concentrically to each other.

7. Manufacturing device according to claim 1, wherein at least one opening of the upper section has a cross-sectional area of at least 1.0 mm², preferably of at least 1.0 cm² and/or at most 500 cm².

8. Manufacturing device according to claim 1, further comprising a gas-sealable container, the lower end of which is closable by the building platform unit and which is preferably removable from the manufacturing device.

9. Manufacturing device according to claim 1, wherein a receiving device is provided around the building shaft and/or at least in sections below a flange section of the building shaft, in order to receive excess build-up material.

10. Manufacturing device according to claim 1, wherein a/the building shaft is closed or closable at its lower end in such a way that build-up material discharged through the at least one opening of the lower section can be received in the building shaft, wherein the build-up material received in this way can be cooled, if necessary, by means of an active cooling device, and/or can be combined with the build-up material or is received and/or removed separately therefrom.

11. Manufacturing device according to claim 1, wherein build-up material received is returned to the manufacturing process.

12. Manufacturing device according to claim 2, wherein the recess comprises or is formed by a slit and/or the cover comprises a belt which is connected to the supporting device, and is either formed circumferentially or has two ends which are connected to the supporting device.

13. Manufacturing method for additive manufacturing of at least one three-dimensional component by layer-by-layer application by at least one coating unit and locally selective solidification of a build-up material by at least one irradiation unit, using a manufacturing device according to claim 1, comprising the following steps:
a) feeding of build-up material onto the building platform unit until an uppermost layer of the build-up material is at least at the level of an upper surface of the upper section so that a space between the upper and lower sections is filled,
b) building up the component, and
c) opening the lower section for discharging of remaining build-up material.

14. Manufacturing method according to claim 13, wherein after step c), the building platform unit is connected to a container which is closed by the building platform unit at its lower end.

15. Manufacturing method according to claim 13, wherein during step b), excess material is received in a receiving device and, if necessary, is combined with the material discharged in step c).

16. Manufacturing process according to claim 13, wherein at least one upper opening and a starting layer are coordinated with each another upon building up of the at least one component, in such a way that upon building up of the at least one component, the starting layer is not arranged directly above the at least one upper opening, wherein at least a section of a starting layer of at least one component is further away from a surface center of the building platform unit than at least a section of an upper opening and/or wherein at least a section of a starting layer of at least one component is less distant from a surface center of the building platform unit than at least a section of an upper opening.

17. Manufacturing method, in particular according to claim 13, for the additive manufacturing of at least one three-dimensional component by layer-by-layer application by at least one coating unit and locally selective solidification of a build-up material by at least one irradiation unit, using a manufacturing device, comprising the following steps: building up the component, as well as at least temporarily receiving build-up material, which is conveyed beyond the building platform unit during the coating process and/or of build-up material which is removed after the manufacturing process, at least partially in the building shaft.

18. System comprising the manufacturing device according to claim 1, as well as build-up material for carrying out a manufacturing method, wherein the build-up material comprises a metal component and/or a ceramic component.
